(19) United States
(12) Patent Application Publication
(10) Pub. No.: US 2013/0113897 A1
(43) Pub. Date: May 9, 2013

(54) PROCESS AND ARRANGEMENT FOR DETERMINING THE POSITION OF A MEASURING POINT IN GEOMETRICAL SPACE

(71) Applicants: ZDENKO KURTOVIC, RUEMLANG (CH); ROBIN PAGAN, STUTTGART (DE)

(72) Inventors: ZDENKO KURTOVIC, RUEMLANG (CH); ROBIN PAGAN, STUTTGART (DE)

(21) Appl. No.: 13/563,600

(22) Filed: Jul. 31, 2012

(30) Foreign Application Priority Data
Sep. 25, 2011 (DE) 102011114115.8

(51) Int. Cl. H04N 13/02

(52) U.S. Cl. 348/50

(57) ABSTRACT

The computerised determination of the position of a measuring point M to be surveyed in three-dimensional space requires two reference points PI and PII with known space coordinates, a digital video camera with an image-capturing sensor and a computer with a screen. The camera is positioned at reference point PI. In this position, it can be rotated to two different alignment positions PI* and PI**. In the first of these rotation positions PI*, the screen shows (among other things) the depiction PII′ of the second reference point PII lying at a distance and a number of marking points (P1′, P2′, PT, P4′, P5′, . . . ) which are marked by abrupt changes in the brightness profile of the image. In the second rotation position PI**, only certain marking points (P1″, P2″, P3″, . . . ) selected according to certain criteria are shown as well as the measuring point M to be surveyed. The position of an imaginary beam in geometrical space, on which the measuring point M and the reference point PI are located, is then calculated from these screen images. Its (M) absolute space coordinates can be calculated from the direction of the beam and the distance value (of PI from M).

The invention refers to the field of surveying technology, in particular to a process and arrangement for determining the position of a measuring point in geometrical space. The process and arrangement according to the invention can be used with currently available hard and software preferably at short ranges of 100 m with a measuring accuracy of (for example) 1 cm and an angular accuracy of 0.005 degrees. To carry out the process according to the invention two points of reference PI and PII are necessary whose space coordinates are known. PII should be at a distance from PI, the setup position for the digital video camera of the surveying instrument. The measuring point M in geometrical space to be located from point PI should be within 100 metres of PI. Greater distances (over 100 m) are conceivable at the price of lower accuracy (>1 cm). The process according to the invention is distinguished by the fact

a) that only one position of the surveying instrument is necessary (in position PI). From this point, the position of an imaginary beam is determined in geometrical space which joins the point M being surveyed with point PI. In this case, the position of the measuring point M in geometrical space is only known to be situated at some point on the beam, whose position in geometrical space is calculated,

b) and that the exact position of the measuring point in geometrical space can be determined when the surveying instrument is extended by a distance meter. By means of the distance meter, it is possible to determine the distance PI-M between the point PI and the measuring point M. Using the position of the “measuring-point beam” calculated in geometrical space, and the distance PI-M, it is possible to locate the exact position of the measuring point M in geometrical space.

With the process according to the invention, any point captured can be recorded automatically by computer control. The process is both flexible and economical.

Further advantages, features and potential applications of the present invention may be gathered from the description which follows, in conjunction with the embodiments illustrated in the drawings.

An example of the sequence of the process according to the invention for determining the position of a measuring point and of the arrangement required for determining the position of a measuring point is shown in the drawings and is described in more detail below.

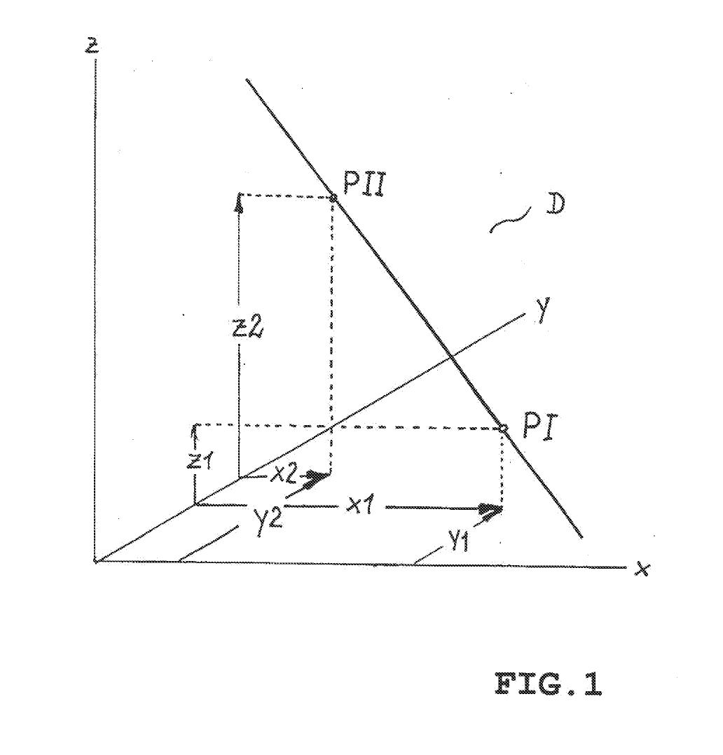

FIG. 1 shows an isometric diagram of the principle for the position of two reference points PI and PII in three-dimensional space by means of their cartesian coordinates;

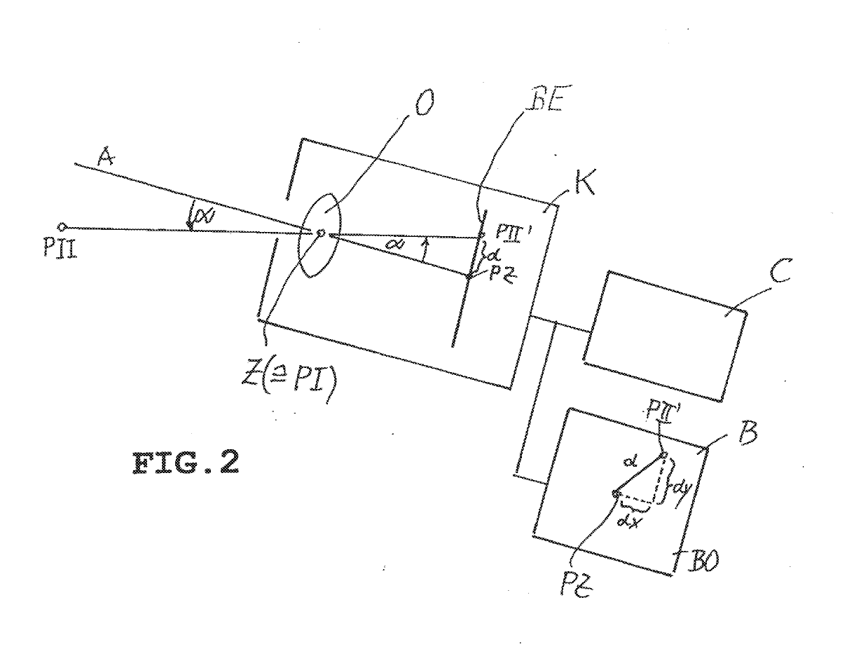

FIG. 2 shows the schematic diagram of a surveying arrangement consisting of a digital video camera with an image-capturing plane and a lens, a computer and a screen, where the camera is set up at a reference point PI with known space coordinates with a certain alignment PI* of its optical axis. The image in the video camera shows a reference point PII with known space coordinates located in space;

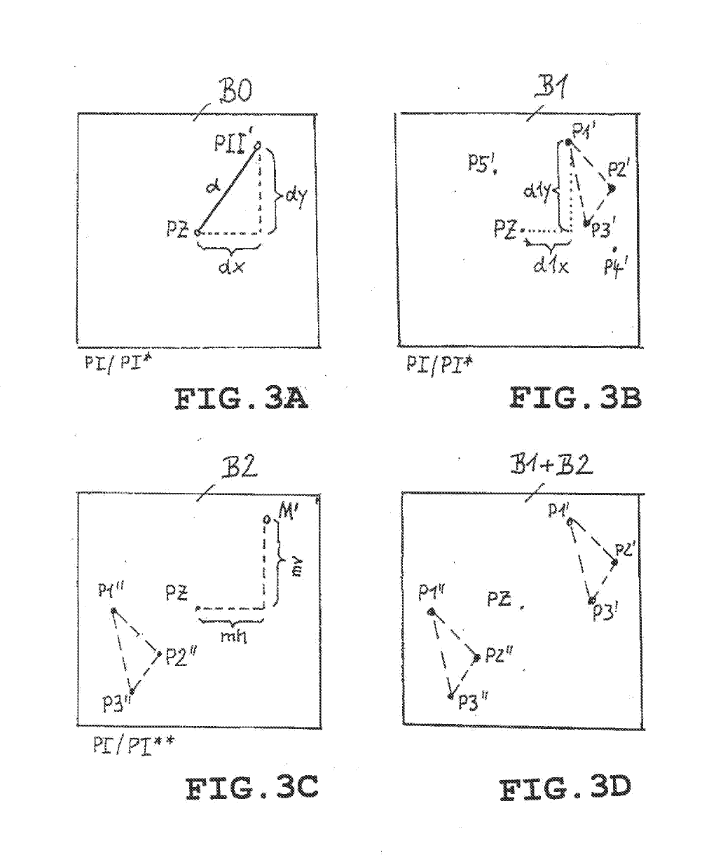

FIG. 3A shows the schematic diagram of an image BO taken by the camera at its setup position PI at alignment PI* on the screen, in which the reference point PII located in three-dimensional space is depicted as PII′;

FIG. 3B shows the schematic diagram of an image B1 taken by the camera at setup position PI at alignment PI* on the screen, in which marking points defined by certain criteria are shown;

FIG. 3C shows the schematic diagram of an image B2 taken by the camera at setup position PI at alignment PI**. In image B2 in FIG. 3C only certain marking points from image B1 in FIG. 3B are shown in an offset position on the screen. These marking points are named FIXED marking points because in image 2 their mutual angular deviation in space is the same as in image 1. It should be noted that the points P1, P1′ and P1″ correspond to one another. The same also applies for points P2, P2′, P2″ etc. In addition, in the screen image B2 (FIG. 3C) a measuring point M located in space is depicted as M′, whose position in space has to be determined;

FIG. 3D shows the schematic diagram of image B2 from FIG. 3C superimposed on image B1 from FIG. 3B (without the depiction M′ of the measuring point M);

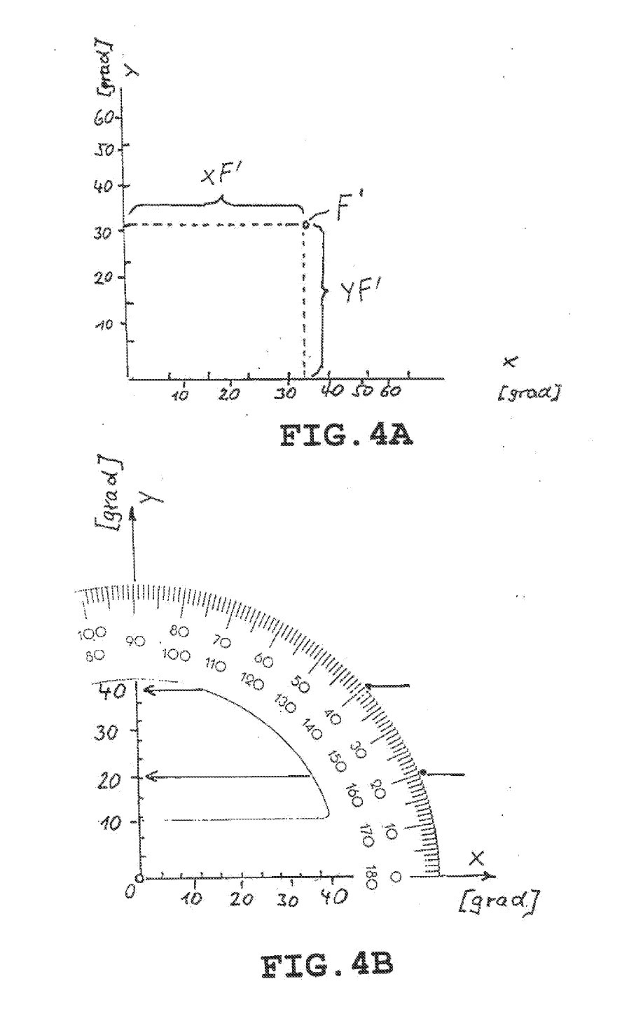

FIG. 4A shows a schematic diagram of the screen plane for stating positions in cartesian x-y coordinates or in angular coordinates;

FIG. 4B shows a schematic diagram for assisting the user in calibrating the screen image according to FIG. 4A in angular coordinates.

The example of the invention refers to a geometrical space defined by cartesian x-y-z coordinates. Theoretically, however, the invention may also refer to geometrical spaces structured in different ways than in cartesian coordinates.

It should be noted that the conversion of coordinate systems is known.

In addition, to simplify the description, it should also be noted that the following mathematical processes are also known:

a) the calculation of the position of an imaginary beam in three-dimensional space using the x-y-z coordinates of two points located on the beam, and

b) the calculation on a screen plane of the position of a beam in three-dimensional space passing through points G and H by means of the known position of a beam in three-dimensional space on which a first point G (not shown) with known space coordinates is located, and by means of the known x-y screen coordinates of the optically created depiction of a second point in space H (not shown) with unknown space coordinates.

FIG. 1 shows an isometric diagram of the principle for two reference points PI and PII in the three-dimensional space D, whose position is determined by means of their cartesian coordinates x1, y1, z1 and x2, y2, z2. For reasons of simplicity, other points in space mentioned in connection with the explanation of the invention are not shown in the diagram in FIG. 1.

FIG. 2 shows the schematic diagram of a surveying arrangement comprising a digital video camera K with an image-capturing plane BE and a lens O, a computer C and a screen B. The camera K the computer C and the screen B are connected with one another. The camera K is set up in such a way that the optical centre Z of its lens O coincides with a reference point PI definable by means of x-y-z space coordinates. It is aligned with a certain alignment PI* in such a way that a point of reference PII located in space with known space coordinates is depicted as point PII′ in the image BO on the screen B. The camera K includes an image-sensor chip with an image-capturing plane. The image-capturing plane BE and the screen B of the camera K consist of addressable pixels (image-point positions) arranged similar to a grid. The optical axis of the camera K passes through the centre Z of the lens O and meets the image-capturing plane BE vertically at point PZ. The screen B of the computer C serves to display the image taken by the digital video camera K appearing at the image-capturing plane, and to mark certain image points.

The screen image BO according to FIG. 2 and FIG. 3A refers to a setup point of the camera K at which the reference point PI (with specifiable x-y-z space coordinates) coincides with the centre Z of the lens O. In this setup position, the camera rotates to a certain position PI* so that the reference point PII (with known x-y-z space coordinates) located in three-dimensional space is displayed in the screen image BO as point PII′.

For the alignment of the camera to a certain alignment position (here PI*) the camera is virtually rotated around point Z at the centre of its lens.

FIG. 3A again shows the schematic diagram of an image BO taken by the camera at its setup position PI at alignment PI* in which the reference point PII located in three-dimensional space is depicted as PII′. The point PZ at which the optical axis meets the image-capturing plane BE at right angles is shown at the centre of the image. The point PII′ is located at a distance d from the point PZ. The position of point PII′ with reference to the centre of the image PZ is defined by the horizontal and vertical distance components dx and dy.

FIG. 3B shows the schematic diagram of an image B1 taken by the camera at setup position PI at alignment PI* on the screen, in which so-called marking points identified for example as small illuminated dots P1′, P2′, P3′, P4′, P5′ . . . are shown. The identification of the marking points is controlled by computer. In the image taken by the camera K, the program selects those points as marking points P1′, P2′, P3′, P4′, P5′ which are characterised by abrupt changes in the brightness profile of the image. Programs with functions of this kind are known in pattern-recognition technology. One example is the “Canny Algorithm”. The Canny Algorithm (see description of Canny Algorithm in “Wikipedia”) is an algorithm which is widely used for edge detection in the field of digital image processing. It provides an image which ideally shows only the edges of the initial image.

Depending on the circumstances, a very large number (one hundred or more) of such image marking points are normally are normally shown in a screen image. For reasons of simplicity, only five such marking points (P1′, P2′, P3′, P4′, P5′) are depicted in the image shown in FIG. 3B. For each of these points P1′, P2′, P3′, P4′, P5′ its screen coordinates (for P1′, shown as dx1 and dy1) are calculated by computer with reference to PZ at the centre of the image B1 in FIG. 3A.

These marking points P1′, P2′, P3′, P4′, P5′ can be interpreted as the depictions of imaginary points in space P1, P2, P3, P4, P5 at the image-capturing level or in the corresponding computer image B1, although the space coordinates of these imaginary points in space P1, P2, P3, P4, P5 are unknown.

The computer first calculates the position of the optical axis A for the following camera position PI/PI*, where PI represents the setup location i.e. the reference point PI whose x-y-z coordinates are known coincides with the centre Z of the lens O of the camera K. For this setup position PI the camera adopts the alignment position PI*.

The direction of the optical axis A in three-dimensional space is calculated by the computer for this position PI/PI* of the camera K. This calculation is based on the specified x-y-z coordinates of the reference points PII and PI and the known distance components dx and dy between PZ and PII′ from FIG. 3A. These data are sufficient to calculate the position of the optical axis of the camera in its position PI/PI*.

FIG. 3C shows a schematic diagram of an image B2 taken by the camera at setup position PI at alignment PI** on the screen. In image B2 (FIG. 3C) only the depictions PI″, P2″, P3″ of the imaginary marking points P1, P2, P3 are shown. These depictions PI″, P2″, P3″ are however offset on the screen surface with reference to the depictions PI′, P2′, P3′ in image 1 (FIG. 3B) of the imaginary marking points P1, P2 and P3.

FIG. 3D shows a schematic diagram of the superimposition of image B1 (FIG. 3B) by the screen image B2 (FIG. 3C) in order to illustrate the FIXED marking points. In this image it is apparent that the depictions P1′, P2′, P3′ (according to image B1 for an alignment position Prof the camera K) of the marking points P1, P2 and P3 have shifted at the screen level with reference to their depictions PI″, P2″, P3″ (according to image B2 for an alignment position PI** of the camera K).

Depictions of the imaginary marking points P4 and P5 (still shown as P4′ and P5′ in image B1 in FIG. 3B) no longer appear in image B2, i.e. the computer program has omitted them because in image B2 (FIG. 3C) only the depictions (PI″, P2″, P3″) of certain marking points (P1, P2, P3) appear which fulfil the criteria of the so-called FIXED marking points. The imaginary marking points P1, P2 and P3 are such FIXED marking points because their depictions P1′, P2′, P3′ (according to image B1 in FIG. 3B) have the same mutual angular deviation compared to their depictions P1″, P2″, P3″ in image B2 (according to FIG. 3C) independently of their “offset” on the screen surface.

By “angular deviation” the following is meant:

The triangles marked by the angle points P1′, P2′, P3′ and P1″, P2″, P3″ which are schematically indicated in B1 (according to FIG. 3B) and image B2 (according to FIG. 3C) will show distortions in their position related to their distance from point PZ when they are shifted on the screen surface. For this reason, FIXED marking points cannot be defined by such a triangular area (the triangles serve only to indicate the angular relationships). The criterion for the FIXED marking points P1, P2 and P3 dictates that their depictions P1′, P2′ and P3′ have the same angular deviations as their depictions P1″, P2″ and P3″.

The depiction P′ in image B1 and the depiction P1″ in image B2 are assigned to the imaginary FIXED marking point P1 and the depictions P2′ and P2″ are assigned in the same way to the FIXED marking point P2 etc.

The depictions P1′, P2′ P3′ (of the imaginary FIXED marking points P1, P2, P3) in image B1 and the depictions P1″, P2″ P3″ (of the imaginary FIXED marking points P1, P2, P3) in image B2 are assigned to one another by computer to prevent confusion from occurring.

For such assignment, known computer programs are available (e.g. programs which function according to the Lucas-Kanada method which is based on the fundamental equation of optical flow; see “Lucas-Kanada method” in “Wikipedia” the free encyclopaedia).

In accordance with FIG. 4A, FIG. 4B and the explanatory notes given below, the image-capturing level BE can be calibrated either in cartesian or in angular coordinates. The cartesian coordinates are based on x and y components referring to an origin (here PZ) of a point-type representation.

In an angular calibration of the image-capturing level BE the position of this point is given with reference to the angle which is formed between the optical axis (passing through Z and PZ) and a beam passing through Z and that point. For this angle, two angular component values are formed which correspond to the cartesian coordinates x and y.

In other words, the distance between two points situated at a distance from one another on the image-capturing level BE or the screen level, can be defined by their differential angular values (angular deviations).

This means, for example, that for two imaginary FIXED marking points P1 and P2, the angular deviation between their depictions and P2′ (in image B1 in FIG. 3B) is the same as the angular deviation between their depictions P1″ and P2″ (in image B2 in FIG. 3C).

For each of these imaginary FIXED marking points P1, P2 and P3 the direction of an imaginary beam passing through three-dimensional space is calculated (as a so-called initial direction value) from their depictions P1′, P2′, P3′ in image B1 (in FIG. 3B), from its screen components (e.g. d1x, d1y for P1′, . . . ) with reference to point PZ, and from the previously calculated direction of the optical axis A for the alignment position PI* of the digital video camera. Such a FIXED marking point and the point of reference PI are located on this beam. For the process in accordance with the invention, at least two FIXED marking points must be known.

In addition, the computerised calculation of the direction of the optical axis in three-dimensional space for the digital video camera K in the alignment position PI** is based on the angular offset value between the depictions P1′ and P1″ of the FIXED marking point P1 and the initial direction value of that marking point P1.

Greater accuracy can be achieved where the computer calculates a mean value from the angular offset values of several FIXED marking points, where of each FIXED marking point (P1, P2, P3) of the offset value is defined as a shift in its depiction point P1′, P2′, P3′ in the screen image B1 in the screen image B1 in relation to its depiction point P1″, P2″, P3″ in its screen image B2, and where this mean value is used as the basis for calculating the direction of the optical axis in three-dimensional space for the digital video camera K in the alignment position PI**.

By taking a mean value, any disrupting effects (e.g. caused by noise) can be cut down to a minimum.

In addition, a measuring point M located in space is shown as M′ in the screen image B2. Its position is calculated as follows:

Computerised calculation of the horizontal mh and vertical my coordinate deviation from the depiction M′ with reference to PZ, and of the position of an imaginary beam in three-dimensional space, on which the measuring point M and the reference point PI lie, from the previously calculated position of the optical axis of the digital video camera K in the alignment position PI** and from the coordinate deviations mh and mv.

Using the process in accordance with the invention it is possible to determine not only the position of an imaginary beam in three-dimensional space on which a measuring point M and the centre Z of the lens of the digital video camera K lie. It is also possible to determine the absolute space coordinates of this measuring point by computer. To do this, the position of the imaginary beam and the distance from the centre Z of the lens (or of the setup position PI of the digital video camera K) to the reference point PII must also be known. This distance can easily be measured using a distance meter, e.g. a laser distance meter. When the distance is known, the computer can calculate the space coordinates of the measuring point from the known position of the imaginary beam and the distance value.

The distance meter is preferably arranged to rotate along with the camera. Its axis then correlates with the direction of the optical axis of the camera K. The computer carries out parallax compensation for deviations in the direction of both axes.

Any deviations in the reference point PI from the centre Z of the lens O which occur when positioning the digital video camera K are identified as deviation values by known processes of measurement. Using these deviation values, the computer then calculates an adjustment in such a way as if the digital video camera K were correctly positioned with the reference point PI coinciding with the centre Z of the lens O.

Similar adjustment calculations are known under the name of “parallax compensation”.

The digital video camera K has a digital zoom function. During the computer-controlled capture of image points on the screen B, certain selected areas of the image are zoomed and enlarged in the display.

According to the invention, a target point may also be selected and marked within the enlarged image of a space point using the screen grid. This permits much more precise marking of the target.

The setting of the digital video camera K to an alignment position (PI*, PII**) takes place by a screen control system. The current alignment of the digital video camera K is displayed on a screen and then adjusted by means of known control data in order to achieve the target alignment position (PI*, PI**).

It has already been noted that the x-y-z coordinates of the reference point PI can be specified. This can be done in a number of ways:

For example, the x-y-z coordinates of a previously known reference point may already be known. They can be determined using “traditional” surveying technology. According to the invention it is preferable to make use of the receiver of a satellite-navigation system to specify the x-y-z coordinates of the reference point PI. In the case of deviations in a receiver which is not aligned to the rotation point PI of the camera, a computer-calculated adjustment takes place as if the receiver were aligned to the rotation point PI of the camera.

According to the invention, an image camera with a three-dimensional image-capturing sensor can be coupled to the arrangement comprising the camera K, the computer C and the screen B. The purpose of this coupling is that the computer a) refers the image taken by the 3D camera for an “inaccurately” measured distance (measured by the “inaccurate” distance meter of the 3D camera) to an “accurately” measured distance (measured by the “accurate” distance meter of the arrangement according to the invention) and/or b) relates the relative image data for the image captured by the three-dimensional image-capturing sensor to the absolute space coordinates determined for a measuring point M of the object.

FIG. 4A shows a schematic diagram of the screen surface for stating positions in cartesian x-y coordinates and in angular coordinates.

FIG. 4B shows a schematic diagram for assisting in the calibration the screen image according to FIG. 4A in angular coordinates.

The screen level (FIG. 4A) is calibrated in cartesian and in angular coordinates. The cartesian coordinates are based on x and y components xF′ and yF′ of a point-type representation (e.g. F′) referring to an origin (here PZ).

In an angular calibration (in degrees) the position of this point F′ is given with reference to the angle which is formed between the optical axis (which passes through Z and PZ in FIG. 2) and a beam passing through Z and F′. For this angle, two angular component values are formed which correspond to the cartesian coordinates xF′ and yF′.

For example, for two points situated at a distance from one another at the screen level, the distance between them can be defined by their differential angular values (angular deviations).

FIG. 4B shows a schematic diagram for assisting in calibrating the screen image according to FIG. 4A in angular coordinates. Figuratively speaking, a screen area originally calibrated in cartesian x-y coordinates can be calibrated for angular coordinates by applying a protractor as follows. The angular positions are marked at the outer edge of the protractor (e.g. for the 20° or 40° positions) and the marked points (here) projected to the ordinate. The same applies for the calibration of the abscisses in angular degrees. This conversion of cartesian to angular coordinates can be done by computer.

The arrangement for carrying out the process according to the invention for determining the position of a measuring point M in geometrical space comprises a digital video camera K a computer C with screen B, to which a digital video camera K is connected, for displaying the image captured by the camera K and for marking image points.

The digital video camera K is characterised by an imaginary optical axis A, a lens O, and an image-capturing plane BE. The optical axis A passes through the centre Z of the lens O and meets the image-capturing plane BE perpendicularly at point PZ. The digital video camera K can be rotated around the imaginary centre point Z of the lens O to different selected alignment positions PI*, PI**. The digital video camera K can be set up at an imaginary reference point PI with known space coordinates in such a way that this reference point PI coincides with the centre Z of the lens O (or in case of deviations, can be adjusted to it).

In a first alignment position PI* of the digital video camera K, the image BO (FIG. 3A) captured by it includes the depiction PII′ of a reference point PII located in geometrical space with specifiable space coordinates. In the same alignment position PI* of the digital video camera K, depictions P1′, P2′, P3′, P4′, P5′, . . . Pn′ of imaginary marking points P1, P2, P3, P4, P5, . . . Pn (with unknown space coordinates) according to image B1 (FIG. 3B) can be captured.

The number of marking points (or their depictions) is unlimited. Depending on circumstances, this may be (e.g.) 100 or 1000. The marking points are generated automatically by computer. Their number depends on the characteristics of the captured image.

In the alignment position P** of the digital video camera K, the image B2 (FIG. 3C) captured by it shows only the depictions P1″, P2″, P3″, P4″, P5″, . . . Pn″ of the imaginary points P1, P2, P3, . . . in space in an offset position on the screen whose mutual angular arrangement in relation to point Z is the same as that of points P1′, P2′, P3′, . . . in image B1 for the alignment position P*.

In addition, in the alignment position PI** according to image B2 (FIG. 3C), the depiction M′ of a measuring point M in geometrical space can also be captured, whose spatial position on an imaginary beam passing through it M and PI is defined by the screen coordinates of the depictions P1′, P2′, P3′ and P1″, P2″, P3″ of the marking points P1, P2, P3 and the space coordinates of the reference points PI and PII.

A rotating arrangement is provided for the adjustment of the digital video camera K to one of its alignment positions (PI*, PI**). The adjustment of the digital video camera K to an alignment position (PI*, PI**) can be controlled by a screen image.

The surveying arrangement according to the invention can be extended by a receiver for a satellite-navigation system such as the Global Positioning System (GPS) for the accurate determination of position, which can be connected to the computer C. This receiver can be adjusted to the rotation point PI of the camera.

The surveying arrangement according to the invention can also be extended by a distance meter connected to the computer C. Preferably this can be mounted in such a way that it rotates with the digital video camera.

Deviations by the centre Z of the lens from the reference point PI when positioning the camera, deviations in the course direction of the optical axis A from the direction of aim of the distance meter, and deviations of the receiver axis from the rotation point Z of the camera can all be compensated by known methods such as parallax compensation.

The surveying arrangement can be coupled to a digital video camera comprising a three-dimensional image-capturing sensor. The digital video camera with the three-dimensional image-capturing sensor can be aligned with an object to be measured. The arrangement for determining the position of a measuring point M in geometrical space can be aligned with a point on this object. Through this coupling, the relative coordinates of an image captured by the three-dimensional image-capturing sensor can be related to the position of the measuring point determined according to the invention.

Digital video cameras of this type with a three-dimensional image-capturing sensor are commercially available, e.g. the “Swiss Ranger SR 4000” manufactured by MESA Imaging AG, Zürich, Switzerland.

### LIST OF REFERENCE SIGNS

A Axis
B Screen
BE Image capturing plane
C Computer
K Camera
O Lens
Z Centre

1-20. (canceled)

21. Computerized process for determining the position of a measuring point (M) in a three-dimensional space (D) with a cartesian coordinate x-y-z system, using an arrangement comprising:
a computer (C) with a screen (B);
a digital video camera (K) is connected to said computer;
said digital video camera (K) includes: a lens (O), said lens (O) includes a center (Z); an image-sensor chip with an image-capture plane (BE) consisting of addressable pixels (image-point positions) arranged in a grid; an optical axis (A) which passes through said center (Z) of lens (O) and meets said image-capture plane (BE) perpendicularly at point PZ;
said screen (B) of said computer (C) depicts an image of said digital video camera and marks points in said image;
said digital video camera (K) occupies a setup position, said optical center (Z) coincides with a reference point (PI) definable by means of x-y-z coordinates;
said digital video camera (K) can be rotated around said reference point (PI) to different alignment positions (PI*, PI**);
said optical axis of said digital video camera (K) assumes a different position in three-dimensional space for each of said alignment positions (PI*, PI**), characterized by the following process steps:
in said alignment position (PI*), said optical axis (A) is aligned with said optical center (Z) of said lens (O) creating an image point (PZ) on said image capture plane (BE) and said screen (BO), reference point (PII) in three-dimensional space definable by x-y-z coordinates creates an image (PII′ of PII) on said screen image capture plane (BE) and on said screen (B) at a distance, d, from said point (PZ), where the position of said point (PII′) with reference to said point (PZ) in the screen plane (B0) is determined by the horizontal (dx) and vertical (dy) distance components between points (PZ and PII′);
computerized calculation of said position of said optical axis (A) in three-dimensional space during alignment position (PI*) of said digital video camera (K) by means of said x-y-z coordinates of said reference points (PII and PI) and said distance components (dx and dy) between points (PZ and PII′);
computerized marking and logging of imaginary marking points (P1, P2, P3, P4, P5, . . . , Pn) located in three-dimensional space, said imaginary marking points (P1, P2, P3, P4, P5, . . . , Pn) depicted as (P1′, P2′, P3′, P4′, P5′, . . . Pn′) on said screen (B1) captured by said digital video camera (K) in said alignment position (PI*), said depicted points (P1′, P2′, P3′, P4′, P5′, . . . , Pn′) characterized and marked by abrupt changes in the brightness profile of an image taken in alignment position (PI*);
computerized marking and logging of at least two of said imaginary marking points (P1, P2, P3, . . . ) located in three-dimensional space, whose depictions (P1″, P2″, P3″, ″,) in an image (B2) captured by said digital video camera (K) in an alignment position (PI**) have the same mutual angle-related deviation as the depiction of points (P1′, P2′, P3′, . . . ,) of said imaginary marking points (P1, P2, P3, . . . ) in said image (B1) captured by said digital video camera (K) in said alignment position PI*, whereby the angle-related position of a point on said screen (B) refers to said angle between said optical axis (A) of said camera (K) and an imaginary beam passing through said center (Z) of said lens (O) and said point, and where said angle is defined by angle components corresponding to the cartesian coordinates of said point;
for every said imaginary marking point (P1, P2, P3,) whose depiction (P1′, P2′, P3′) appears in said screen image (B1) during alignment of said camera in said position (PI*) and whose depiction (P1″, P2″, P3″) appears in said screen image (B2) during alignment of said camera in said position (PI**), said course of an imaginary beam passing through three-dimensional space is calculated as an initial direction value by means of said screen components (d1x, d1y for P1′ etc,) of each said imaginary marking point in screen image (B1) with reference to said point (PZ) and by means of said previously calculated position of said optical axis (A) during alignment position (PI*) of said digital video camera on which said imaginary marking points and said reference point (PI) are located;
computerized calculation of said direction of said optical axis (A) in three-dimensional space for said digital video camera (K) in said alignment position PI** based on said angle-related shift value between said depictions (P1′, P1″) of said imaginary marking point (P1) and said initial direction value of said imaginary marking point (P1); and,
computerized determination of the horizontal (mh) and vertical (mv) coordinate deviation of the depiction (M′) in image (B2) of said measuring point (M) in three-dimensional space with reference point (PZ) in image (B2) and calculation of said position of an imaginary beam in three-dimensional space on which said measuring point (M) and said reference point (PZ) are located, by means of the previously calculated position of said optical axis (A) for said digital video camera (K) in said alignment position (PI**) and said coordinate deviations (mh and mv).

22. Process in accordance with claim 21, characterized in that a computerized calculation of an average value for the angle-related offset values of several imaginary marking points takes place, where said offset value for each said imaginary marking point (P1, P2, P3,) is defined as the offset in the point of its depiction (P1′, P2′, P3′) in the screen image (B1) with reference to its point of depiction (P1″, P2″, P3″) in said screen image (B2), and where said average value is used as the basis for said calculation of said direction of said optical axis in three-dimensional space for said digital video camera (K) in said alignment position (PI**).

23. Process in accordance with claim 21, characterized in that for a given distance value from the setup position (PI) of the digital video camera (K) to the measuring point (M) in three-dimensional space, the spatial coordinates of the measuring point (M) are determined by computer from the direction of an imaginary beam passing through the measuring point (M) and the reference point (PI) and from the distance value.

24. Process in accordance with claim 21, characterized in that, when said digital video camera (K) is being positioned, any deviations in said reference point (PI) from the center (Z) of the lens (O) are recorded as deviation values by known processes of measurement and used to calculate the required adjustment as if the digital video camera (K) were correctly positioned with the reference point (PI) coinciding with the center (Z) of said lens (O).

25. Process in accordance with claim 24, characterized in that said adjustment is calculated by computer by means of parallax compensation.

26. Process in accordance with claim 21, characterized in that said digital video camera (K) has a digital zoom function and that during the computer-controlled capture of depiction points, selected image areas can be shown enlarged on said screen (B), and that in the enlarged image of a point in space a certain target area can be marked within this image by means of the screen framing grid.

27. Process in accordance with claim 21, characterized in that the positioning of said digital video camera (K) to an alignment position (PI*, PI**) is controlled by means of a screen image.

28. Process in accordance with claim 21, characterized in that a receiver for a satellite-navigation system is used to define the xyz coordinates for the reference point (PI).

29. Process in accordance with claim 28, characterized in that, in the case of deviations in a receiver which is not aligned to the rotation point (PI) of said camera, a computer-calculated adjustment takes place as if said receiver were aligned to said rotation point (PI) of said camera.

30. Process in accordance with claim 23, characterized in that a laser distance meter is used to measure said distance value.

31. Process in accordance with claim 30, characterized in that, where said distance meter can rotate with said camera, computerized parallax compensation takes place with reference to said optical axis and aiming beam of said distance meter.

32. Process in accordance with any of the claims 23, characterized in that an image camera with a three-dimensional image-capturing sensor is coupled to the arrangement comprising said camera (K), said computer (C) and said screen (B), where said relative coordinates of an image captured by the three-dimensional image-capturing sensor are related to the space coordinates of said measuring point (M) in three-dimensional space.

33. Arrangement for determining the position of a measuring point (M) in three-dimensional space D with a cartesian coordinate x-y-z system, comprising:
a digital video camera (K) and a computer (C);
a screen (B) connected to said camera (K), said screen displays said image captured by said camera (K) and marks said image points thereon;
said digital video camera (K) has an optical axis (A), a lens (O) and an image-recording plane (BE), said optical axis (A) passes through said center (Z) of said lens (O) and meets said image-recording plane (BE) at a right angle;
said digital video camera (K) positioned at a reference point (PI), said reference point having specified space coordinates, said reference point (PI) coincides with said center (Z) of said lens (O);
said digital video camera (K) is rotatable around said center point (Z) of said lens (O) into alignment positions (PI*, PI**);
said first alignment position (PI*) of said digital video camera (K) produces an image (BO), said image (BO) includes a reference point (PII) with known specified space coordinates located in geometrical space;
in said alignment position (PI*) of said digital video camera (K), an image (B1) captured by said camera includes depictions (P1′, P2′, P3′, P4′, P5′, . . . , Pn′) of imaginary points in space (P1, P2, P3, P4, P5, . . . , Pn) with unknown space coordinates;
an image (B2) captured by said digital video camera (K) in said second alignment position (PI″) includes depictions (P1″, P2″, P3″, . . . ) of said imaginary points in space (P1, P2, P3, . . . );
an image (B1 and B2), by superposition, depicts image points (P1″, P2″, P3″, . . . ) in said second alignment position (PI″) having mutual angular arrangement with respect to said depictions of image points (P1′, P2′, P3′, . . . ) In said first alignment position (PI*);
said image (B2) includes the depiction M′ of a measuring point M in space, and that the spatial position of an imaginary beam passing through this measuring point M and the reference point (PI) is defined by the screen data for the alignment positions (PI*, PI**) of said camera (K) and the space coordinates of the reference points (PI and PII).

34. Arrangement in accordance with claim 33, wherein said digital video camera (K) is rotatable to an alignment position (PI*, PI**).

35. Arrangement in accordance with claim 33, wherein said digital video camera (K) can be moved into an alignment position (PI*, PI**) by means of a screen image.

36. Arrangement in accordance with claim 33, wherein said arrangement for determining the position of a measuring point M in geometrical space includes a positioning receiver connected with the computer (C), which is based on a satellite-navigation system such as the Global Positioning System (GPS).

37. Arrangement in accordance with claim 36, wherein said positioning receiver is aligned with rotation point (PI) of said camera.

38. Arrangement in accordance with claim 33, wherein said distance meter with connection to computer (C) is provided for recording the distance from measuring point (M) to the digital video camera (K).

39. Arrangement in accordance with claim 33, wherein said digital video camera with said computer connection comprises a three-dimensional image-capturing sensor aligned to an object to be measured and that the arrangement for determining the position of a measuring point (M) in geometrical space is aligned to a point on this object and that the relative coordinates of the image captured by the three-dimensional image-capturing sensor can be linked with the space coordinates of the measuring point (M).

40. Arrangement in accordance with claim 33, wherein deviations of said reference point (PI) from said center (Z) of said lens (O) occurs when said digital video camera K is positioned, and said deviations can be compensated by a known method as if said digital video camera (K) were correctly positioned with said reference point (PI) coinciding with said center (Z) of said lens (O).
